(19) United States
(12) Patent Application Publication
(10) Pub. No.: US 2006/0029920 A1
(43) Pub. Date: Feb. 9, 2006

(54) Method and system for knowledge assessment using confidence-based measurement

(76) Inventors: James E. Bruno, Los Angeles, CA (US); Charles J. Smith, Encinitas, CA (US); Patrick G. Engstrom, Longmont, CO (US); Timothy M. Adams, Aurora, CO (US); Kevin D. Warr, Parker, CO (US); Michael J. Cushman, Lakewood, CO (US); Brian D. Webster, Arvada, CO (US); Frederick M. Bollin, Denver, CO (US)

Correspondence Address: LAW OFFICES OF ROYAL W. CRAIG;A PROFESSIONAL CORPORATION, SUITE 153, 10 NORTH CALVERT STREET, BALTIMORE, MD, 21202, US

(21) Appl. No.: 11/187,606

(22) Filed: Jul. 23, 2005

Related U.S. Application Data
(63) Continuation-in-part of application No. 10/115,157, filed on Apr. 3, 2002, now Pat. No. 6,921,268.

(51) Int. Cl. G09B 7/00

(52) U.S. Cl. 434/323

(57) ABSTRACT

A method for knowledge assessment and encouraging learning via the administration, scoring, remediation, and reiteration of a confidence-based assessment (CBA) test. The CBA test comprises a plurality of multiple choice questions directed to categorical topics, and two-dimensional answers by which a subject indicates both their answer and level of confidence category of their answer. The answers include a plurality of full-confidence choices consisting of single-choice answers (A), (B) or (C), a plurality of partial-confidence choices consisting of sets of multiple single-choice answers (A or B), (B or C), (A or C), and an unsure answer. Scoring entails giving maximum points for correct full-confidence answers, partial points for correct partial-confidence answers, no score for not knowing, and a maximum penalty for wrong answers in any category. The answers are compiled and displayed as a knowledge profile to the subject that separates answers into quadrants of doubt, misinformation, unknown and mastery. The CBA test method is re-administering as often as desired, and when taken multiple times a composite knowledge profile is compiled and to the subject to show improvement.

### CROSS-REFERENCE TO RELATED APPLICATION(S)

The present application is a continuation-in-part of application Ser. No. 10/115,157, filed 10 Apr. 3, 2002.

### BACKGROUND OF THE INVENTION

1. Field of the Invention

The present invention relates to knowledge testing methods, and more particularly, to a method and system for Confidence-Based Assessment (“CBA”), in which one answer generates two metrics with regard to the individual's confidence and correctness in his or her response to facilitate an approach for immediate remediation.

2. Description of the Background

Traditional multiple choice, one-dimensional (right/wrong), testing techniques are forced-choice tests. This format requires individuals to choose one answer, whether they know the correct answer or not. If there are three possible answers, random choice will result in a 33% chance of scoring a correct answer. One-dimensional scoring algorithms usually reward guessing. Typically, wrong answers are scored as zero points, so that there is no difference in scoring between not answering at all and taking an unsuccessful guess. Since guessing sometimes results in correct answers, it is always better to guess than not to guess. It is known that a small number of traditional testing methods provide a negative score for wrong answers, but usually the algorithm is designed such that eliminating at least one answer shifts the odds in favor of guessing. So for all practical purposes, guessing is still rewarded.

In addition, one-dimensional testing techniques encourage individuals to become skilled at eliminating possible wrong answers and making best-guess determinations at correct answers.

If individuals can eliminate one possible answer as incorrect, the odds of picking a correct answer reach 50%. In the case where 70% is passing, individuals with good guessing skills are only 20% away from passing grades, even if they know almost nothing. Thus, the one-dimensional testing format and its scoring algorithm shift the purpose of individuals, their motivation, away from self-assessment and receiving accurate feedback, toward inflating test scores to pass a threshold.

Confidence-Based Assessments, on the other hand, are designed to eliminate guessing and accurately assess people's true state of knowledge. In the 1980s, Dr. James Bruno pioneered information referenced testing (IRT) in direct response to the foregoing situation. IRT is a two dimensional (recognition and confidence) test scoring procedure that places less emphasis on restrictive response environments (students can indicate “I don't know”). The formative evaluation is in two parts. The first part is to provide feedback for student learning. The second is to provide feedback to provide support for instructional programs. Based on a decision theory model of testing rather than a psychometric model, IRT was found to be especially valuable, acceptable and applicable for individual student assessment. A number of studies were conducted throughout the late 1980s and early 1990s, and research papers were published in peer reviewed journals detailing the results. The IRT procedure then employed an objective, optically scannable, partial credit type of test scoring system that measured accurate information, misinformation, lack of information and partial information in a student knowledge base. IRT has also been used extensively by the FAA, Nuclear Regulatory Agency, and major utility companies in areas where misinformation could have serious legal, political and social consequences. In the past, applications of the IRT concept have relied on paper score sheets and computers with optical scan capabilities.

The IRT approach was implemented as a Confidence-Based Assessment (“CBA”) Testing System in the above-cited parent application Ser. No. 10/115,157, filed Apr. 3, 2002.

This Confidence-Based Assessment approach is designed to eliminate guessing and accurately assess people's true state of knowledge. The CBA format covers three states of mind: confidence, doubt, and ignorance. Individuals are not forced to choose a specific answer, but rather they are free to choose one answer, two answers, or no answer. The CBA answer format more closely matches the states that test takers actually think and feel. Individuals quickly learn that guessing is penalized, and that it is better to admit doubts and ignorance than to feign confidence. Moreover, since CBA discourages guessing, test takers shift their focus from test-taking strategies and trying to inflate scores, toward honest, self-assessment of their actual knowledge and confidence. In fact, the more accurately and honestly individuals self-assess their own knowledge and feelings of confidence, the better their numerical scores.

The present application refines the Confidence-Based Assessment approach by compiling a standard multiple choice test into a structured CBA. After individuals complete a CBA, their set of answers are used to generate a knowledge profile. The knowledge profile precisely segments answers into meaningful regions of knowledge, giving individuals and organizations rich feedback as to the areas and degrees of mistakes (misinformation), unknowns, doubts and mastery.

### SUMMARY OF THE INVENTION

It is, therefore, an object of the present invention to provide a knowledge and misinformation assessment system for more accurate measurement of knowledge and information.

It is another object to provide a Confidence-Based Assessment (CBA) approach that compiles a standard three answer (“A”, “B”, and “C”) multiple choice test into a structured CBA format with seven possible answers that cover three states of mind: confidence, doubt, and ignorance to more closely match the state of mind of the test taker.

It is another object to provide a CBA scoring algorithm that gives maximum points for confidently held correct answers, partial points for unsure correct answers, no score for not knowing, and a maximum penalty for wrong answers. Individuals quickly learn that guessing is penalized, and that it is better to admit doubts and ignorance than to feign confidence.

It is another object to discourage guessing by encouraging test takers to shift their focus from test-taking strategies and trying to inflate scores, toward honest, self-assessment of their actual knowledge and confidence. In fact, the more accurately and honestly individuals self-assess their own knowledge and feelings of confidence, the better their numerical scores.

It is another object to provide an assessment method by which a CBA set of answers are separated into quadrants, whereby each set of results is displayed as a knowledge profile made up of a mastery score, a mastery gap (or information gap), and a confidence gap, to more precisely segment answers into meaningful regions of knowledge, giving individuals and organizations rich feedback as to the areas and degrees of mistakes (misinformation), unknowns, doubts and mastery.

These and other objects are accomplished by the present invention, which is a method for knowledge assessment and encouraging learning, comprising the steps of administering a confidence-based assessment (CBA) test comprising a plurality of multiple choice questions directed to categorical topics, and two-dimensional answers by which a subject indicates both their answer and level of confidence category of their answer. The answers include a plurality of full-confidence choices consisting of single-choice answers (A), (B) or (C), a plurality of partial-confidence choices consisting of sets of multiple single-choice answers (A or B), (B or C), (A or C), and an unsure answer. The method includes scoring the CBA test by giving maximum points for correct full-confidence answers, partial points for correct partial-confidence answers, no score for not knowing, and a maximum penalty for wrong answers in any category. The answers are compiled and displayed as a knowledge profile to the subject that includes a graphical illustration arranged with correctness of the answer along one axis and confidence in the answer another axis, and further separated into quadrants of doubt, misinformation, unknown and mastery. In addition to the graphical knowledge profile, a numerical scoring profile is derived and displayed to the subject as percentage of answers assigned to each quadrant.

Once the CBA test is administered, the results compiled, and feedback given, the present method encourages remedial learning by displaying (in association with the knowledge profile) all multiple choice questions along with the subject's answer, the correct answer, an explanation, and references to related learning materials for said questions.

The foregoing CBA test method is re-administered, and when taken multiple times a composite knowledge profile is compiled and to the subject to show improvement.

This approach gives both the subject and the administering organization rich feedback as to the areas and degrees of mistakes (misinformation), unknowns, doubts and mastery.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a screen print illustrating the present Question & Answer Format with seven response options;

FIG. 2 is a perspective graphical illustration of the four Knowledge Quadrants indicating confidence and knowledge grid according to the present invention.

FIG. 3 is a perspective graphical illustration of an exemplary Knowledge Profile indicating quadrant percentages in response to answers, with hyperlinks to Questions & Answers (Q&A).

FIG. 4 is a screen print of an exemplary remediation presentation.

FIG. 5 is a graphical illustration of how multiple Knowledge Profiles are compiled and displayed to allow individuals to measure their improvement.

FIG. 6 is a graphical illustration of time metrics, e.g., a diagram indicating the average time per question.

### DETAILED DESCRIPTION OF THE PREFERRED EMBODIMENTS

The present invention is a robust method and system for Confidence-Based Assessment (“CBA”), in which one answer generates two metrics with regard to the individual's confidence and correctness in his or her response to facilitate an approach for immediate remediation. This is accomplished through three primary tools:
1. A testing and scoring format that completely eliminates the need to guess at answers. This in a more accurate evaluation of “actual” information quality.
2. A scoring method that more accurately reveals what a person: (1) accurately knows; (2) partially knows; (3) doesn't know; and (4) is sure that they know, but is actually incorrect.
3. A resulting knowledge profile that focuses only on those areas that truly require instructional or reeducation attention. This eliminates wasted time and effort training in areas where attention really isn't required.

The foregoing tools are implemented by a five-step method or “learning cycle”:

(1) Take an assessment. This begins with the step of compiling a standard three answer (“A”, “B”, and “C”) multiple choice test into a structured CBA format with seven possible answers for each question that cover three states of mind: confidence, doubt, and ignorance, thereby more closely matching the state of mind of the test taker.

(2) Review the knowledge profile—their results qualitatively segmented by quadrant. Given a set of answers the method proceeds to implement a CBA scoring algorithm that gives maximum points for confidently held correct answers, partial points for unsure correct answers, no score for not knowing, and a maximum penalty for wrong answers. Individuals quickly learn that guessing is penalized, and that it is better to admit doubts and ignorance than to feign confidence. The CBA set of answers are then compiled by separating them into quadrants, whereby each set of results is displayed as a knowledge profile made up of a mastery score, a mastery gap (or information gap), and a confidence gap, to more precisely segment answers into meaningful regions of knowledge, giving individuals and organizations rich feedback as to the areas and degrees of mistakes (misinformation), unknowns, doubts and mastery. The knowledge profile is a much better metric of performance and competence, especially in the context of the corporate training environment where it encourages better-informed, higher information quality employees reducing costly knowledge and information errors, and increasing productivity.

(3) Review the question, answer, and explanation with regard to the material

(4) Review the further training links to gain a better understand of the subject material

(5) Iteration: Retaking Assessments. The five-step process can be repeated as many times as the individual needs to in order to gain an appropriate understanding of the content.

Each of the method steps is described in greater detail below:

Compiling the CBA Test and Scoring Format

Compiling the present CBA format entails converting a standard multiple choice test comprising three answer (“A”, “B”, and “C”) multiple choice questions into questions answerable by seven options, that cover three states of mind: confidence, doubt, and ignorance.

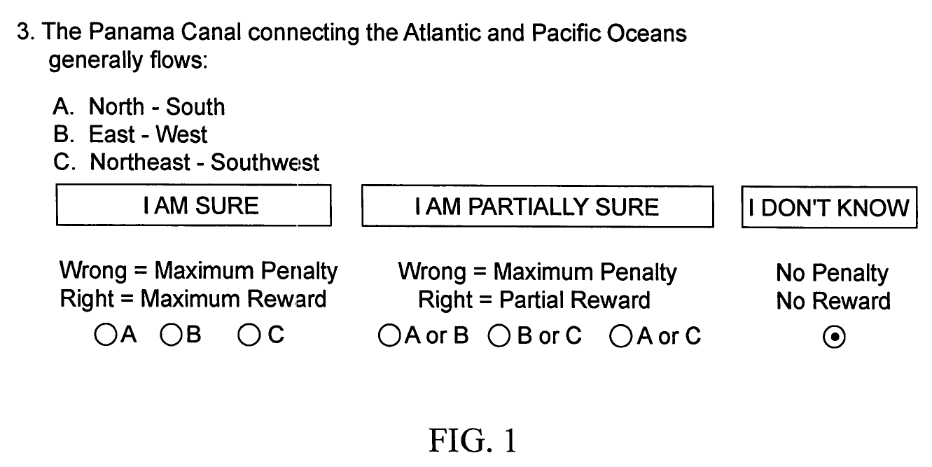

FIG. 1 is a screen print illustrating the present Question & Answer Format with seven response options, the ‘I Don't Know’ being the default answer. The exemplary question is “3. The Panama Canal connecting the Atlantic and Pacific oceans generally flows:”? The subject is required to provide two-dimensional answers according to the present invention where the Subject indicates both their answer and level of confidence in their choice. The one-dimensional choices are listed under the question as follows: A. North-South; B. East-West; C.

Northeast-Southwest. However, the subject is required to answer by two-dimensional answers, which are categorized under headings “I Am Sure”; “I Am Partially Sure” and “I Don't Know”. The “I Am Sure” category includes the three single-choice answers (A-C). The “I Am Partially Sure” category allows the subject to choose between sets of any two single-choice answers (A or B, B or C, A or C). There is also an “I Don't Know” category that includes one specific “I Don't Know” answer which is the default answer. The three-choice seven-answer format is based on research that shows that fewer than three choices introduces error by making it easier to guess at an answer and get it right. More than three choices can cause a level of confusion (remembering previous choices) that negatively impacts the true score of the test. The subject is also presented with scoring information indicating that a wrong “I Am Sure” answer carries a maximum penalty, a right “I Am Sure” answer carries a maximum reward, a wrong “I Am Partially Sure” answer carries a maximum penalty; a right “I Am Partially Sure” answer carries a partial reward, and the “I Don't Know” answer carries No Penalty.

The Subject must carefully answer each question in only one of the three available categories as follows:
100% sure (selects only one answer)
50% certain (select a pair of choices that best represents the answer (A or B) (B or C), or (A or C).
Don't know

This CBA scoring algorithm gives the maximum points for confidently held correct answers, partial points for unsure correct answers, no score for not knowing, and a maximum penalty for wrong answers in any category. Thus, if the Subject is reasonably sure (50% certain) and the correct answer is one of the two choices then partial credit is earned. However, the Subject is heavily penalized for indicating confidence in an incorrect choice. This CBA answer format more closely matches the states that test takers actually think and feel. Overvaluing of information (confidently held misinformation) results in a substantial reduction in the overall score, and subjects quickly learn that guessing is penalized, and that it is better to admit doubt and ignorance than to feign confidence. This encourages test takers to shift their focus from test-taking strategies and trying to inflate scores, toward honest, self-assessment of their actual knowledge and confidence. In fact, the more accurately and honestly individuals self-assess their own knowledge and feelings of confidence, the better their numerical scores.

Compiling the Knowledge Profile from a Set of CBA Answers

Given a set of CBA answers the present method compiles a Knowledge Profile by determining how the answers fit into Knowledge Quadrants indicating regions of knowledge: doubt, misinformation, unknown and mastery.

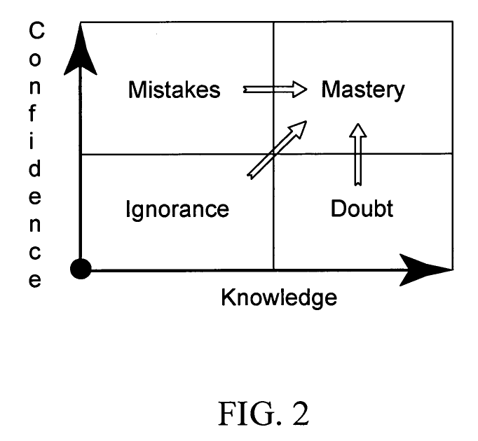

FIG. 2 is a perspective graphical illustration of the four Knowledge Quadrants indicating confidence and knowledge grid according to the present invention. The Knowledge Quadrants indicate regions of knowledge: doubt, misinformation, unknown and mastery resulting from the subject's answers to the foregoing confidence-based assessment. The graph shows the correctness of the answer (knowledge) along the x-axis and the confidence in the answer along the y-axis. Each of the subject's answers to all of the CBA questions may be plotted into one of the four quadrants as follows:
1. A mistake (a.k.a “misinformation”) is an incorrect answer in either “I'm sure” or “I'm partially sure” categories.
2. An unknown is an “I don't know” answer.
3. A doubt is a correctly answered “I'm partially sure” choice.
4. Mastery is a correctly answered “I'm sure” choice.

After individuals complete a set of CBA test questions as described above, their set of answers are separated into their respective quadrants, and the results are displayed as the Knowledge Profile.

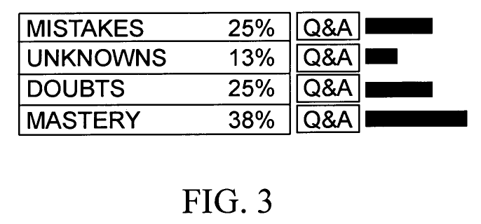

FIG. 3 is a perspective graphical illustration of an exemplary Knowledge Profile indicating quadrant percentages in response to answers, with hyperlinks to Questions & Answers (Q&A). The percentage or score is assigned to each quadrant depending on how the individual did on the assessment. Specifically, the percentage of mistake answers (per total answers) is calculated and displayed as a bar graph, as is the percentage of unknown answers (per total answers), the percentage of doubt answers (per total answers), and the percentage of mastery answers (correct full-confidence answers per total answers). These percentages may be readily derived from the answers and Knowledge Quadrants in which they are plotted in FIG. 2. The Knowledge Profile of FIG. 3 precisely segments answers into meaningful regions of knowledge, giving individuals and organizations rich feedback as to the areas and degrees of mistakes, unknowns, doubts and mastery.

The visual and qualitative results from the Knowledge Profile are preferably also converted into numeric scores by which a scoring profile is compiled. The scoring profile is made up of a mastery score and may also include a mastery gap, (sometimes referred to as the information gap), and a confidence gap.

The mastery score Is a combination of knowledge and confidence. It is the summation or points from the following algorithm: maximum positive points for surely correct answers, ½ points for partially-sure, correct answers, zero points for uninformed answers, and maximum negative points for wrong sure or partially-sure answers. In addition, the summation must be non-negative (since wrong sure or partially-sure answers are computed as a negative, there is a potential for negative scores). The mastery score must be non-negative (greater than or equal to zero) and if not, the summation is adjusted to zero.

The mastery gap is the difference between a perfect mastery score (100) and the actual mastery score.

The confidence gap is the appropriateness of confidence relative to the knowledge demonstrated. A positive confidence gap means a person is relatively-overconfident, while a negative confidence gap means a person is relatively under confident.

The scoring profile inclusive of mastery score and mastery gap affords a much greater precision Confidence-Based Assessment. They reflect the distinctions among knowing, guessing, not knowing, and believing one knows, distinctions which have significant real-world implications that affect individual and organizational competence, performance and risks. These distinctions are undetectable in binary, right-or-wrong test results. With the present method when individuals see misinformation/mistakes in their knowledge profiles as in FIG. 3, they are surprised. Surprise creates a teachable moment, where the mind is more receptive to feedback and new information.

This leads to the next step, which is remediation.

Remediation

To improve learning, it is important to provide specific learning materials, immediately, when the learner is ready for them. This entails a targeted learning plan (or “Personal Learning Plan”), where learners see all the questions sorted by knowledge quadrants.

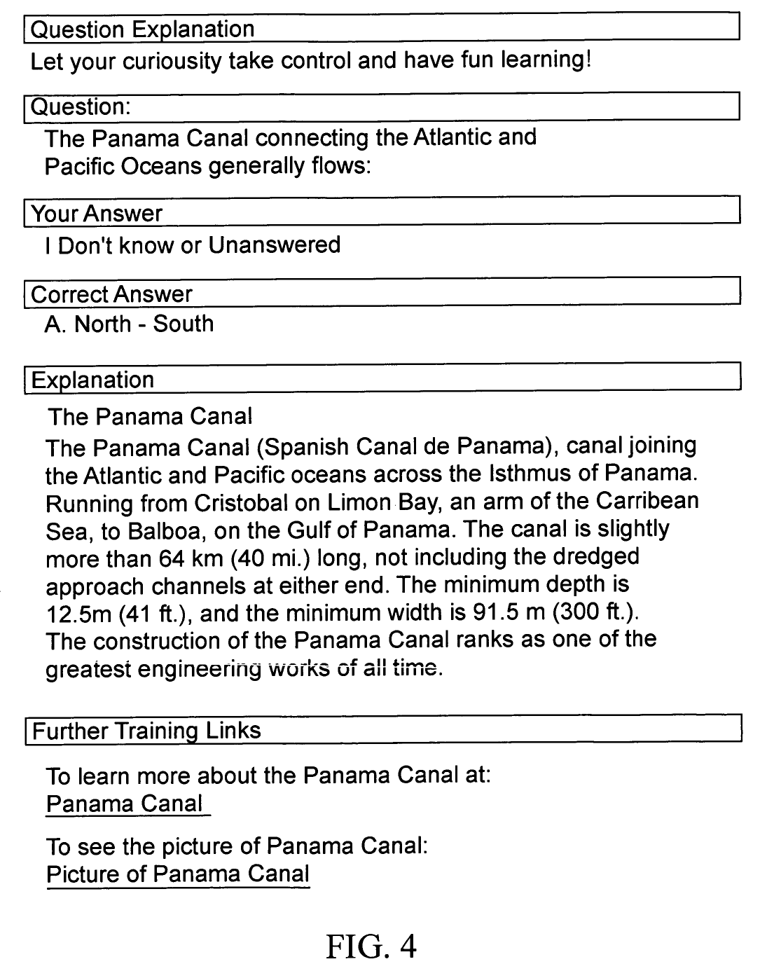

FIG. 4 is a screen print of an exemplary remediation presentation, which is delivered immediately when the subject chooses a hyperlink to Questions & Answers (Q&A) as seen in FIG. 3. For each question, the subjects can see the question, their answer, the correct answer, and an explanation. For example, for the illustrated question a complete explanation is given for the correct answer: “Panama Canal joining the Atlantic and Pacific oceans across the Isthmus of Panama, Running from Cristobal on Limon Bay, an arm of the Caribbean Sea, to Balboa, on the Gulls of Panama, the canal is slightly more than 64 km (40 ml) long, not including the dredged approach channels at either end. The minimum depth is 12.5 m (41 ft), and the minimum width is 91.5 m (300 ft). The construction of the Panama Canal ranks as one of the greatest engineering works of all time.” In addition, further links are provided to related learning materials, such as “To learn more about Panama Canal”, and “see the picture of Panama Canal”. The links are also to documents, courses, books, other locations on the internet or other database information that will help the individual better understand the material. This form of remediation reminds the subject to let their curiosity take control and have fun learning.

Increasing Retention by Iteration

Confidence is highly correlated with knowledge retention. As stated above, the present method asks learners their level of confidence, and measures confidence. However, it moves further by moving subjects to full confidence in their answers in order to reach true knowledge, thereby increasing knowledge retention. This is accomplished by an iteration step. After individuals review the results of the material in CBA as above, learners can retake the assessment, as many times as necessary to reach true knowledge. This yields multiple Knowledge Profiles which help individuals understand and measure their improvement throughout the assessment process.

When an individual retakes an assessment, the questions are randomized using a random number generator, such that individuals do not see the same questions in the same order from the previous assessment. Questions are developed in a database in which there is a certain set of questions to cover a subject area. To provide true knowledge acquisition and testing of the material, a certain number of questions are presented each time rather than the full bank of questions. This allows the individuals to develop and improve with their understanding of the material over time.

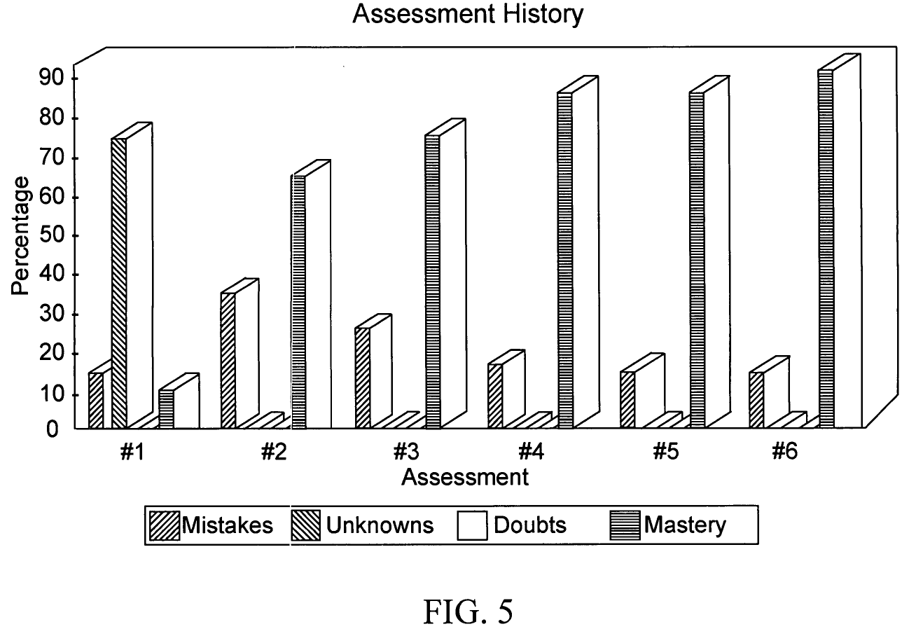

FIG. 5 is a graphical illustration of how multiple Knowledge Profiles are compiled and displayed to allow individuals to measure their improvement. In this display, the individual can review and determine how well they are doing in each knowledge quadrant and how they are improving. The assessment history provides the individual with a metric to determine both improvements in confidence and knowledge.

In addition to the foregoing, the individual can be measured on how long it takes to answer a question as well as how long it takes to complete to an assessment. These metrics both may be used as an indicator of mastery.

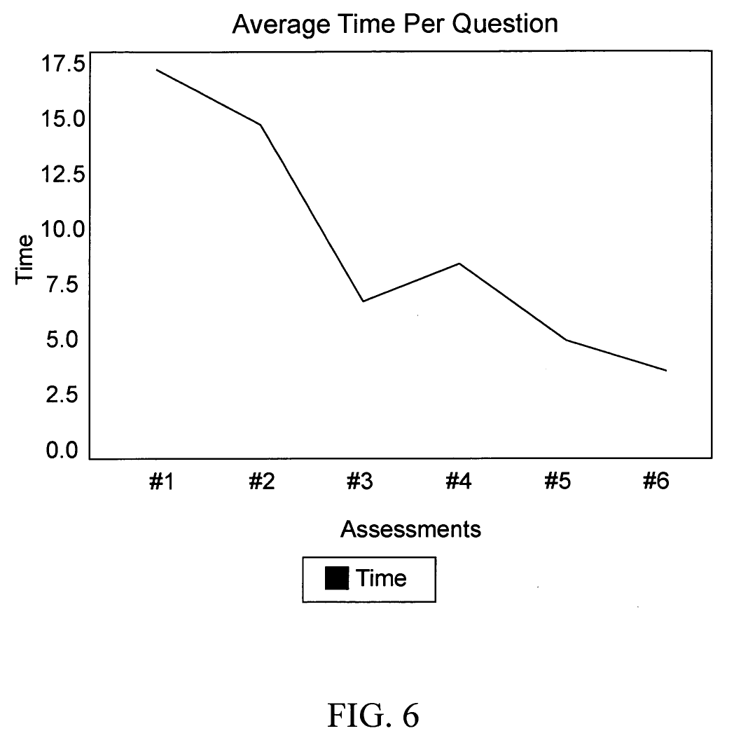

FIG. 6 is a graphical illustration of time metrics, e.g., a diagram indicating the average time per question. As shown in FIG. 6, the diagram indicates the average time per question. The length in time it takes to answer a question and complete an assessment is a good indicator of mastery. The more confident an individual is, the less time it will take. The less time it takes, the more ingrained the knowledge.

Industry Applications

1. Certification

The confidence-based assessment can be used as a confidence-based certification instrument. In this instance, the confidence-based certification process would not provide any remediation but only provide a score and/or knowledge profile. The confidence-based assessment would indicate whether the individual had any confidently held misinformation in any of the certification material being presented. This would also provide, to a certification body, the option of prohibiting certification where misinformation exists within a given subject area. Since the CBA method is more precise then current one-dimensional testing, confidence-based certification increases the reliability of certification testing and the validity of certification awards.

2. Adaptive Learning

The confidence-based assessment can apply to adaptive learning approaches in which one answer generates two metrics with regard to confidence and knowledge. In adaptive learning, the use of video or scenarios to describe a situation helps the individual work through a decision making process that supports their learning and understanding. In adaptive learning techniques, individuals repeat the process a number of times to develop familiarity with how they would handle a given situation. For scenarios or simulations, CBA adds a new dimension to how confident individuals are in their decision process. The use of the confidence-based assessment using an adaptive learning approach enables individuals to identify where they are uninformed and have doubts in their performance and behavior. Repeating adaptive learning until individuals become fully confident increases the likelihood that the individuals will act rapidly and consistently with their training.

3. Survey

The confidence-based assessment can be applied as a confidence-based survey instrument, which incorporates the choice of three possible answers, in which individuals indicate their confidence in and opinion on a topic. As before, individuals select an answer response from seven options to determine their confidence and understanding in a given topic or their understanding of a particular point of view. The question format would be related to attributes or comparative analysis with a product or service area in which both understanding and confidence information is solicited. For example, a marketing firm might ask, “Which of the following is the best location to display a new potato chip product? A) at the checkout; B) with other snack products; C) at the end of an aisle.” The marketer is not only interested in the consumer's choice, but the consumer's confidence or doubt in the choice. Adding the confidence dimension increases a person's engagement in answering survey questions and gives the marketer richer and more precise survey results.

In all the foregoing applications, the present method gives more accurate measurement of knowledge and information. Individuals learn that guessing is penalized, and that it is better to admit doubts and ignorance than to feign confidence. They shift their focus from test-taking strategies and trying to inflate scores toward honest self-assessment of their actual knowledge and confidence. This gives subjects as well as organizations rich feedback as to the areas and degrees of mistakes, unknowns, doubts and mastery.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

We claim:

1. A method for knowledge assessment and encouraging learning, comprising the steps of:
administering a confidence-based assessment (CBA) test comprising a plurality of multiple choice questions directed to categorical topics, and two-dimensional answers by which said subject indicates both their answer and level of confidence category of their answer, said answers including a plurality of full-confidence choices consisting of single-choice answers, a plurality of partial-confidence choices consisting of sets of multiple single-choice answers, and an unsure answer;
scoring the CBA test by giving maximum points for correct full-confidence answers, partial points for correct partial-confidence answers, no score for not knowing, and a maximum penalty for wrong answers in any category;
compiling and displaying a knowledge profile to the subject from said scored CBA test comprising a graphical illustration arranged with correctness of the answer along one axis and confidence in the answer another axis, with said two-dimensional answers plotted thereon and separated into quadrants of doubt, misinformation, unknown and mastery, said knowledge profile additionally including a scoring profile indicating percentage of answers assigned to each of said quadrant;
encouraging remedial learning by said subject by, in association with displaying said knowledge profile to said subject, also displaying all of said multiple choice questions to said subject along with the subject's answer, a correct answer, an explanation, and references to related learning materials for said questions;
re-administering said confidence-based assessment (CBA) test with a plurality of different multiple choice questions related to said categorical topics;
scoring the re-administered CBA test by giving maximum points for correct full-confidence answers, partial points for correct partial-confidence answers, no score for not knowing, and a maximum penalty for wrong answers in any category;
compiling and displaying a composite knowledge profile to the subject from said CBA tests as administered and readministered displaying improvement.

2. The method for knowledge assessment and encouraging learning according to claim 1, wherein all of said steps of re-administering the CBA test, scoring the re-administered CBA test, and compiling and displaying a composite knowledge profile are repeated a plurality of times to encourage knowledge retention by iteration.

3. The method for knowledge assessment and encouraging learning according to claim 1, wherein said two-dimensional answers generate two metrics of confidence and correctness.

4. The method for knowledge assessment and encouraging learning according to claim 3, wherein said step of administering a confidence-based assessment (CBA) test further comprises a plurality of multiple choice questions directed to categorical topics, each having three full-confidence single-choice answers, three partial-confidence choices consisting of sets of said multiple single-choice answers, and an unsure answer.

5. The method for knowledge assessment and encouraging learning according to claim 4, wherein said subject indicates full-confidence by “I AM SURE”, partial confidence by “I AM PARTIALLY SURE” and unsure by “I DON'T KNOW”.

6. The method for knowledge assessment and encouraging learning according to claim 4, wherein failure to answer is interpreted as a default unsure answer.

7. The method for knowledge assessment and encouraging learning according to claim 6, wherein said knowledge quadrants are named and displayed as: “misinformed” (or “mistakes”); “uninformed” (or “unknowns”); “partially informed” (or “doubts”); and “fully informed” (or “true knowledge” or “mastery”).

8. The method for knowledge assessment and encouraging learning according to claim 7, wherein any answer to any one of said multiple choice questions may be plotted in one of the four quadrants as follows:
a mistake is an incorrect answer for either “I'm sure” or “I'm partially sure”;
an unknown is an “I don't know” reply;
a doubt is a correctly answered “I'm partially sure” choice;
mastery is a correctly answered “I'm sure” choice.

9. The method for knowledge assessment and encouraging learning according to claim 1, wherein said step of compiling and displaying a knowledge profile to the subject further comprises displaying a numerical scoring profile in which qualitative results from said quadrants are converted into numeric scores including a mastery score, mastery gap, and confidence gap.

10. The method for knowledge assessment and encouraging learning according to claim 9, wherein said mastery score comprises a summation of maximum positive points for surely correct answers, ½ points for partially-sure, correct answers, zero points for uninformed answers, and maximum negative points for wrong sure or partially-sure answers.

11. The method for knowledge assessment and encouraging learning according to claim 9, wherein said mastery gap comprises the difference between a perfect mastery score (100) and the actual mastery score.

12. The method for knowledge assessment and encouraging learning according to claim 11, wherein said confidence gap comprises the appropriateness of confidence relative to the knowledge demonstrated.

13. The method for knowledge assessment and encouraging learning according to claim 1, wherein said step of encouraging remedial learning comprises displaying hyperlinks to related learning materials.

14. The method for knowledge assessment and encouraging learning according to claim 1, wherein said step of re-administering said confidence-based assessment (CBA) test with a plurality of different multiple choice questions related to said categorical topics comprises random questions selected by topic using a random number generator, so that individuals do not see the same questions in the same order from the previous assessment.

15. The method for knowledge assessment and encouraging learning according to claim 1, wherein said step of compiling and displaying a knowledge profile to the subject further comprises measuring how long it takes said subject to answer a question as well as how long it takes to complete to an assessment, both as an indicator of mastery.

16. A method for knowledge assessment and encouraging learning, comprising the steps of:
administering a confidence-based assessment (CBA) test comprising a plurality of multiple choice questions directed to categorical topics, and two-dimensional answers by which said subject indicates both their answer and level of confidence category of their answer, said answers including a plurality of full-confidence choices consisting of single-choice answers, a plurality of partial-confidence choices consisting of sets of multiple single-choice answers, and an unsure answer;
scoring the CBA test by giving maximum points for correct full-confidence answers, partial points for correct partial-confidence answers, no score for not knowing, and a maximum penalty for wrong answers in any category;
compiling and displaying a knowledge profile to the subject from said scored CBA test comprising a graphical illustration arranged with correctness of the answer along one axis and confidence in the answer another axis, with said two-dimensional answers plotted thereon and separated into quadrants of doubt, misinformation, unknown and mastery, said knowledge profile additionally including a scoring profile indicating percentage of answers assigned to each of said quadrant;
encouraging remedial learning by said subject by, in association with displaying said knowledge profile to said subject, also displaying all of said multiple choice questions to said subject along with the subject's answer, a correct answer, an explanation, and references to related learning materials for said questions.

17. The method for knowledge assessment and encouraging learning according to claim 16, wherein said step of administering a confidence-based assessment (CBA) test further comprises a plurality of multiple choice questions directed to categorical topics, each having three full-confidence single-choice answers, three partial-confidence choices consisting of sets of said multiple single-choice answers, and an unsure answer.

18. The method for knowledge assessment and encouraging learning according to claim 17, wherein said subject indicates full-confidence by “I AM SURE”, partial confidence by “I AM PARTIALLY SURE” and unsure by “I DON'T KNOW”.

19. The method for knowledge assessment and encouraging learning according to claim 18, wherein any answer to any one of said multiple choice questions may be plotted in one of the four quadrants as follows:
a mistake is an incorrect answer for either “I'm sure” or “I'm partially sure”;
an unknown is an “I don't know” reply;
a doubt is a correctly answered “I'm partially sure” choice;
mastery is a correctly answered “I'm sure” choice.

20. The method for knowledge assessment and encouraging learning according to claim 16, wherein said step of compiling and displaying a knowledge profile to the subject further comprises measuring how long it takes said subject to answer a question as well as how long it takes to complete to an assessment, both as an indicator of mastery.
